(19) United States
(12) Patent Application Publication
(10) Pub. No.: US 2026/0006359 A1
(43) Pub. Date: Jan. 1, 2026

(54) LAMP FOR VEHICLE AND VEHICLE INCLUDING THE SAME

(71) Applicant: HYUNDAI MOBIS CO., LTD., Seoul (KR)

(72) Inventor: Myeong Je KIM, Yongin-si (KR)

(73) Assignee: HYUNDAI MOBIS CO., LTD., Seoul (KR)

(21) Appl. No.: 19/194,363

(22) Filed: Apr. 30, 2025

(30) Foreign Application Priority Data
Jun. 28, 2024 (KR) 10-2024-0085718

(51) Int. Cl. H04R 1/02; F21S 43/20; H04R 3/04; H04R 17/00

(52) U.S. Cl. CPC H04R 1/028; F21S 43/20; H04R 1/025; H04R 3/04; H04R 17/00; H04R 2430/01; H04R 2499/13

(57) ABSTRACT

A lamp for a vehicle is provided. The lamp includes a lamp housing part having an internal space to accommodate a light source, an outer lens part coupled to one side of the lamp housing part and configured to cover the internal space, and a vibration part fixed to the lamp housing part or the outer lens part. The vibration part includes a polarized piezoelectric element that is polarized in a direction D1, and a first electrode and a second electrode respectively facing two opposite sides based on the direction D1 in which the piezoelectric element is polarized. The piezoelectric element outputs a sound by being vibrated by a change in voltage applied to the first electrode and the second electrode over time.

### CROSS-REFERENCE TO RELATED APPLICATION

This application claims priority to and the benefit of Korean Patent Application No. 10-2024-0085718 filed in the Korean Intellectual Property Office on Jun. 28, 2024, the entire contents of which are incorporated herein by reference for all purposes.

### BACKGROUND

### 1. Field

The present disclosure relates to a lamp for a vehicle and a vehicle including the same.

### 2. Description of the Related Art

Recently, with the increasing demand for entertainment functions in addition to transportation functions required for vehicles, there has been a growing need for lamps mounted in the vehicles and having additional functions in addition to simple lighting functions. For example, recently, a lamp for a vehicle has additionally adopted a function capable of performing communication with the outside.

In the related art, the lamp for a vehicle has performed the function of communication with the outside by means of visual information such as lighting images or light distribution patterns of the lamp for a vehicle. Meanwhile, the methods of performing the function of communication with the outside also include a method using auditory information, such as sounds, in addition to the method using visual information. However, because the lamp for a vehicle in the related art adopts a watertight structure to prevent moisture from accumulating in the lamp for a vehicle, it is difficult to mount a speaker, which is configured to output a sound, in the lamp for a vehicle.

### SUMMARY

The present disclosure has been made in an effort to add a function, which is capable of outputting a sound, to a lamp for a vehicle without affecting performance of the lamp for a vehicle.

In a general aspect of the disclosure, a lamp for a vehicle, includes: a lamp housing part having an internal space configured to accommodate a light source; an outer lens part coupled to one side of the lamp housing part and configured to cover the internal space; and a vibration part fixed to the lamp housing part or the outer lens part, wherein the vibration part includes a polarized piezoelectric element configured to be polarized in a direction D1, and a first electrode and a second electrode respectively facing two opposite sides based on the direction D1 in which the piezoelectric element is polarized, and wherein the piezoelectric element outputs a sound by being vibrated by a change in voltage applied to the first electrode and the second electrode over time.

The piezoelectric element may be provided as a plurality of piezoelectric elements spaced apart from one another in the direction D1 in which the piezoelectric element is polarized, wherein the first electrode may be provided as a plurality of first electrodes, wherein the second electrode may be provided as a plurality of second electrodes, and wherein the vibration part may include a structure in which the first electrode, the piezoelectric element, the second electrode, and the piezoelectric element are disposed alternately in the direction D1 in which the piezoelectric element is polarized.

The outer lens part may include: a first outer lens region having a first transmittance rate corresponding to a transmittance rate for visible rays; and a second outer lens region having a second transmittance rate corresponding to a transmittance rate for visible rays lower than the first transmittance rate, wherein the vibration part may be fixed to the second outer lens region.

The vibration part may be fixed to a lower region of an inner surface of the lamp housing part.

The lamp may further include a lamp bezel part having one side fixedly coupled to the lamp housing part, the lamp bezel part being provided to at least partially face the outer lens part, wherein the vibration part may be fixed to a region of the outer lens part that faces the lamp bezel part, wherein the lamp bezel part may have a separation prevention region formed in a region facing the vibration part, and the lamp bezel part is spaced apart from the vibration part, and wherein at least a part of the separation prevention region may be positioned in a lower region of the vibration part.

The separation prevention region may include a section having a concave shape and is configured to surround the vibration part.

The lamp may further include: a power supply part configured to supply power to the first electrode and the second electrode; a signal supply part configured to supply the power supply part with an electrical signal related to a sound intended to be outputted by the vibration part; a circuit part configured to connect the power supply part and the signal supply part and provide a path through which the electrical signal is transmitted; and a resistor member provided on the circuit part.

The circuit part may include a first circuit part and a second circuit part provided in parallel with each other, wherein the resistor member may be provided only on the first circuit part or the second circuit part.

The lamp may further include: a power supply part configured to supply power to the first electrode and the second electrode; a signal supply part configured to supply the power supply part with an electrical signal related to a sound intended to be outputted by the vibration part; a circuit part configured to connect the power supply part and the signal supply part and provide a path through which the electrical signal is transmitted; and a filter member provided on the circuit part and configured to attenuate an electrical signal having a frequency that exceeds a predetermined value among the electrical signals.

The circuit part may include a first circuit part and a second circuit part provided in parallel with each other, wherein the filter members may respectively be provided on the first circuit part and the second circuit part.

The lamp may further include: a power supply part configured to supply power to the first electrode and the second electrode; a signal supply part configured to supply the power supply part with an electrical signal related to a sound intended to be outputted by the vibration part; and a circuit part configured to connect the power supply part and the signal supply part and provide a path through which the electrical signal is transmitted, wherein the signal supply part configured to adjust intensity of an electrical signal within a predetermined frequency range among the electrical signals.

The lamp may further include: a power supply part configured to supply power to the first electrode and the second electrode; a signal supply part configured to supply the power supply part with an electrical signal related to a sound intended to be outputted by the vibration part; and a circuit part configured to connect the power supply part and the signal supply part and provide a path through which the electrical signal is transmitted, wherein the vibration part may be fixed to the outer lens part, and wherein the signal supply part may be configured to adjust intensity of the electrical signal on the basis of a temperature of the outer lens part.

The signal supply part may be configured to increase the intensity of the electrical signal when the temperature of the outer lens part is a predetermined value or less.

The signal supply part may be configured to increase the intensity of the electrical signal as the temperature of the outer lens part decreases.

The signal supply part may be configured to at least one of: increase the intensity of the electrical signal, which has a frequency exceeding a predetermined value among the electrical signals, as the temperature of the outer lens part decreases; or decrease the intensity of the electrical signal, which has a frequency of a predetermined value or less among the electrical signals, as the temperature of the outer lens part decreases.

The piezoelectric element may have one of a circular shape, a square shape, and a rectangular shape.

The resistor member may include a variable resistor member, wherein the variable resistor member may be configured to change resistance depending on a change in frequency of the electrical signal.

The lamp may further include: a power supply part configured to supply power to the first electrode and the second electrode; a signal supply part configured to supply the power supply part with an electrical signal related to a sound intended to be outputted by the vibration part; a first circuit part and a second circuit part configured to connect the power supply part and the signal supply part and define a path through which the electrical signal is transmitted, the first circuit part and the second circuit part being provided in parallel with each other; a filter member provided on the first circuit part and configured to attenuate an electrical signal having a frequency that exceeds a predetermined value among the electrical signals; and a switch member configured to connect the signal supply part to the first circuit part and the second circuit part so that the signal supply part is selectively connected to the first circuit part or the second circuit part.

The lamp may be provided in at least one of a left side of the vehicle, a right side of the vehicle, or a combination thereof.

The lamp may be provided only at one of the left side of the vehicle or the right side of the vehicle that is adjacent to a sidewalk when the vehicle travels.

According to the present disclosure, it is possible to add the function, which is capable of outputting a sound, to the lamp for a vehicle without affecting the performance of the lamp for a vehicle.

### BRIEF DESCRIPTION OF THE DRAWINGS

FIG. 1 is a view illustrating a state in which an outer lens part is spaced apart from a lamp housing part and a lamp bezel part in a lamp for a vehicle according to a first embodiment of the present disclosure.

FIG. 2 is a view illustrating a state in which a vibration part is fixed to a lamp housing part of a lamp for a vehicle according to a second embodiment of the present disclosure.

FIG. 3 is a cross-sectional view of the vibration part of the lamp for a vehicle according to the present disclosure, i.e., a view illustrating a state made before power is provided to an electrode.

FIG. 4 is a cross-sectional view of the vibration part of the lamp for a vehicle according to the present disclosure, i.e., a view illustrating one state made after power is provided to the electrode.

FIG. 5 is a cross-sectional view of the vibration part of the lamp for a vehicle according to the present disclosure, i.e., a view illustrating another state made after power is provided to the electrode.

FIG. 6 is a view illustrating a first example of a piezoelectric element provided in the vibration part of the lamp for a vehicle according to the present disclosure.

FIG. 7 is a view illustrating a second example of the piezoelectric element provided in the vibration part of the lamp for a vehicle according to the present disclosure.

FIG. 8 is a view illustrating a third example of the piezoelectric element provided in the vibration part of the lamp for a vehicle according to the present disclosure.

FIG. 9 is a cross-sectional view illustrating a stacked structure of a vibration part applied to a lamp for a vehicle according to a third embodiment of the present disclosure.

FIG. 10 is a view illustrating some components of a lamp for a vehicle according to a fourth embodiment of the present disclosure when viewed from a rear region of a lamp bezel part.

FIG. 11 is an enlarged view illustrating cross-sectional structures of a separation prevention region provided on the lamp bezel part in FIG. 10 and surrounding components thereof.

FIG. 12 is a view illustrating a first example including components for supplying electrical signals to the vibration part provided in the lamp for a vehicle according to the present disclosure.

FIG. 13 is a view illustrating a second example including components for supplying electrical signals to the vibration part provided in the lamp for a vehicle according to the present disclosure.

FIG. 14 is a view illustrating a third example including components for supplying electrical signals to the vibration part provided in the lamp for a vehicle according to the present disclosure.

FIG. 15 is a view illustrating an example of a traveling state of a vehicle according to the present disclosure.

### DETAILED DESCRIPTION

Hereinafter, a lamp for a vehicle and a vehicle according to the present disclosure will be described with reference to the drawings.

### Lamp for Vehicle

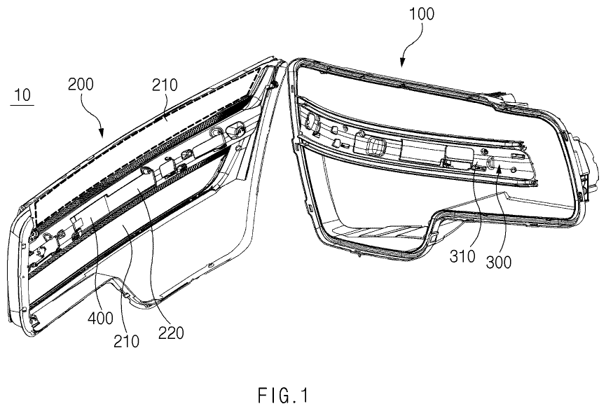

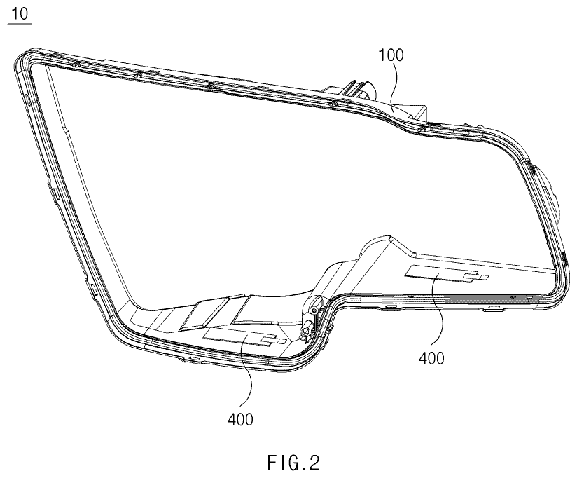

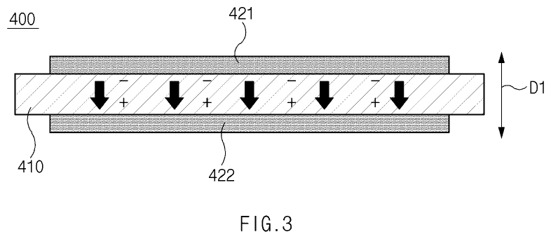

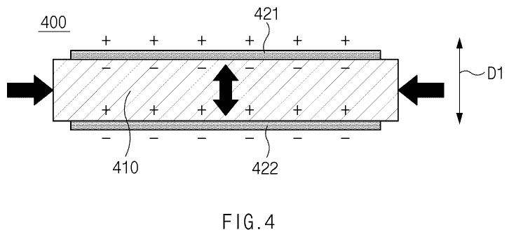

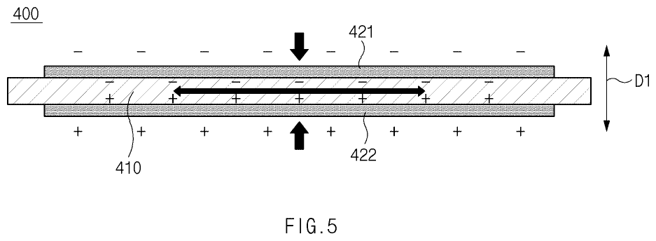

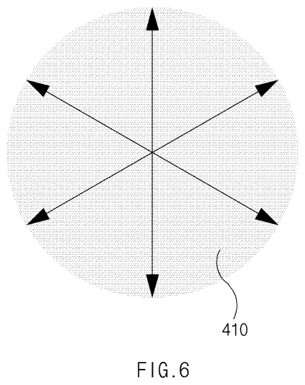

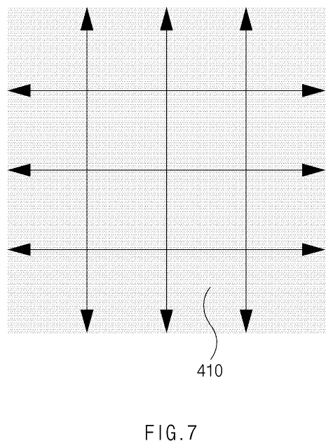

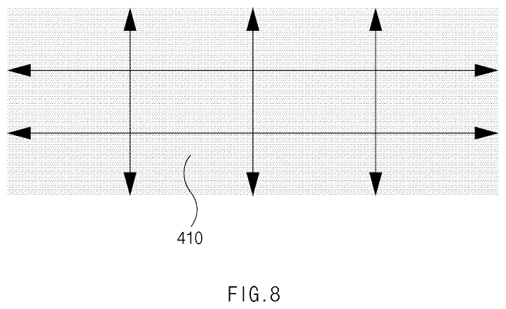

FIG. 1 is a view illustrating a state in which an outer lens part is spaced apart from a lamp housing part and a lamp bezel part in a lamp for a vehicle according to a first embodiment of the present disclosure, and FIG. 2 is a view illustrating a state in which a vibration part is fixed to a lamp housing part of a lamp for a vehicle according to a second embodiment of the present disclosure. FIG. 3 is a cross-sectional view of the vibration part of the lamp for a vehicle according to the present disclosure, i.e., a view illustrating a state made before power is provided to an electrode, and FIG. 4 is a cross-sectional view of the vibration part of the lamp for a vehicle according to the present disclosure, i.e., a view illustrating one state made after power is provided to the electrode. FIG. 5 is a cross-sectional view of the vibration part of the lamp for a vehicle according to the present disclosure, i.e., a view illustrating another state made after power is provided to the electrode, and FIG. 6 is a view illustrating a first example of a piezoelectric element provided in the vibration part of the lamp for a vehicle according to the present disclosure. FIG. 7 is a view illustrating a second example of the piezoelectric element provided in the vibration part of the lamp for a vehicle according to the present disclosure, and FIG. 8 is a view illustrating a third example of the piezoelectric element provided in the vibration part of the lamp for a vehicle according to the present disclosure.

With reference to FIGS. 1 and 2, a lamp 10 for a vehicle (hereinafter, referred to as a ‘lamp’) according to the present disclosure may include a lamp housing part 100 having an internal space configured to accommodate a light source, and an outer lens part 200 coupled to one side of the lamp housing part 100 and configured to cover the internal space. More specifically, the outer lens part 200 may be fixedly coupled to the lamp housing part 100. The light emitted from the light source may propagate to the outside through the outer lens part 200, such that predetermined light distribution patterns and lighting images may be formed.

Meanwhile, according to the present disclosure, the lamp 10 may not only form predetermined light distribution patterns and lighting images, like the lamp in the related art, but also generate a sound. More specifically, the lamp 10 according to the present disclosure may output a sound by vibrating the lamp housing part 100 or the outer lens part 200.

In order to achieve the above-mentioned object, the lamp 10 according to the present disclosure may include a vibration part 400 fixed to the lamp housing part 100 or the outer lens part 200. The vibration part 400 may be configured to output a sound by vibrating the lamp housing part 100 or the outer lens part 200. FIG. 1 illustrates a state in which the vibration part 400 is fixed to the outer lens part 200, and FIG. 2 illustrates a state in which the vibration part 400 is fixed to the lamp housing part 100. In addition, the vibration part 400 may be accommodated in the internal space formed in the lamp housing part 100.

With continued reference to FIG. 1, the lamp 10 according to the present disclosure may further include a lamp bezel part 300 having one side fixedly coupled to the lamp housing part 100, the lamp bezel part 300 being provided to at least partially face the outer lens part 200. More specifically, based on FIG. 1, one region of the outer lens part 200 may face the lamp bezel part 300 in case that the outer lens part 200 is assembled to the lamp housing part 100.

Meanwhile, the vibration part 400 of the lamp 10 according to the present disclosure may include a polarized piezoelectric element 410. That is, according to the present disclosure, the vibration part 400 may include the piezoelectric element 410 in a polarized state in which one side thereof is positively charged and the other side is negatively charged unless a temperature becomes a Curie temperature or higher or exceeds a predetermined range and a reverse voltage is applied in a direction opposite to a direction of an electric field in the piezoelectric element. Any material may be used for the piezoelectric element 410 without limitation as long as the material can be polarized. For example, the piezoelectric element 410 may be made of a ceramic material. Meanwhile, in the present specification, as illustrated in FIGS. 3 to 5, a direction in which a positively charged region and a negatively charged region face each other in the piezoelectric element 410 is defined as a direction D1 in which the piezoelectric element is polarized.

With continued reference to FIGS. 3 to 5, the lamp 10 according to the present disclosure may include a first electrode 421 and a second electrode 422 that respectively face two opposite sides based on the direction D1 in which the piezoelectric element 410 is polarized. That is, the first electrode 421 and the second electrode 422 may be provided to respectively face or be in contact with the negatively charged region and the positively charged region in the piezoelectric element 410.

A process in which the lamp 10 according to the present disclosure outputs a sound will be described below. When power is supplied to the first electrode 421 and the second electrode 422 through a power supply part to be described below, the first electrode 421 and the second electrode 422 are charged. In particular, when power with alternating current is supplied to the first electrode 421 and the second electrode 422, voltages of the first electrode 421 and the second electrode 422 vary over time. Therefore, according to the present disclosure, an electric force applied to the piezoelectric element 410 by the first electrode 421 and the second electrode 422 also varies over time as voltages applied to the first electrode 421 and the second electrode 422 vary over time, such that the piezoelectric element 410 performs motions in a longitudinal direction and a width direction. The motions are converted into vibration of the piezoelectric element 410, and the lamp housing part 100 or the outer lens part 200 is vibrated by the vibration of the piezoelectric element 410, thereby outputting a sound to the outside. For example, as illustrated in FIG. 3, before power is supplied to the first electrode 421 and the second electrode 422, the first electrode 421 and the second electrode 422 are not electrified, such that an external force is not applied to the piezoelectric element 410. Then, as illustrated in FIG. 4, when a first time elapses after power is supplied to the first electrode 421 and the second electrode 422, the first electrode 421 and the second electrode 422 are positively and negatively charged, respectively, such that the piezoelectric element 410 expands in a thickness direction while receiving forces in directions toward the first electrode 421 and the second electrode 422. Then, as illustrated in FIG. 5, when a second time elapses after the power is supplied to the first electrode 421 and the second electrode 422, the first electrode 421 and the second electrode 422 are negatively and positively charged, respectively, such that the piezoelectric element 410 contracts in the thickness direction while receiving forces in directions away from the first electrode 421 and the second electrode 422. Thereafter, the states illustrated in FIGS. 3 to 5 are repeated, such that the piezoelectric element 410 vibrates.

Meanwhile, with reference back to FIG. 1, in addition, according to the present disclosure, the vibration part 400 may be provided at a position in the lamp 10 at which the vibration part 400 may be protected from external direct sunlight. More specifically, the vibration part 400 may be fixed to a region of the outer lens part 200 or the lamp housing part 100 in which visible ray permeability is low. For example, as illustrated in FIG. 1, in case that the vibration part 400 is fixed to the outer lens part 200, the outer lens part 200 may include a first outer lens region 210 having a transmittance rate for visible rays, i.e., a first transmittance rate, and a second outer lens region 220 having a transmittance rate for visible rays, i.e., a second transmittance rate lower than the first transmittance rate, and the vibration part 400 may be fixed to the second outer lens region 220. In contrast, as illustrated in FIG. 2, in case that the vibration part 400 is fixed to the lamp housing part 100, the vibration part 400 may be fixed to a lower region of an inner surface of the lamp housing part 100. In this case, the sound generated by the vibration of the vibration part 400 may propagate in a forward/rearward direction through a lower side of the lamp, i.e., a lower side of the vehicle.

Meanwhile, the piezoelectric element 410, which constitutes the vibration part 400, may have a plate shape. For example, as illustrated in FIG. 6, the piezoelectric element 410 may have a circular plate structure. As illustrated in FIG. 7, the piezoelectric element 410 may have a square plate structure. As illustrated in FIG. 8, the piezoelectric element 410 may have a rectangular plate structure.

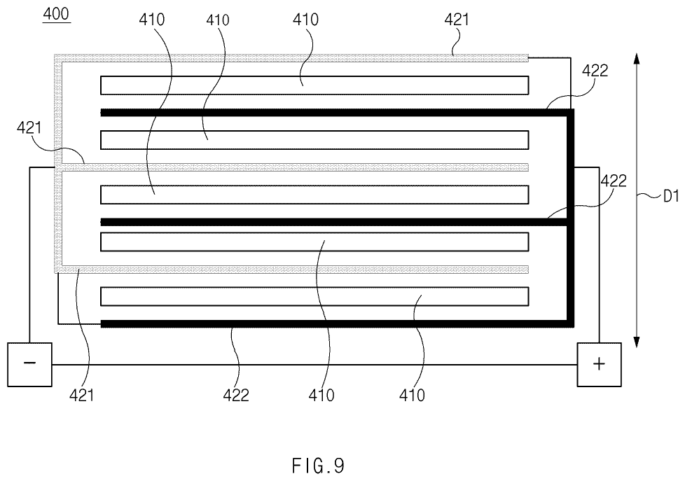

FIG. 9 is a cross-sectional view illustrating a stacked structure of a vibration part applied to a lamp for a vehicle according to a third embodiment of the present disclosure.

With reference to FIG. 9, the vibration part 400 provided in the lamp 10 according to the third embodiment of the present disclosure may have a structure in which the piezoelectric element 410 and the electrodes 421 and 422 are alternately and repeatedly stacked. That is, with reference to FIG. 9, in the third embodiment of the present disclosure, the piezoelectric element 410 may be provided as a plurality of piezoelectric elements 410 spaced apart from one another in the direction D1 in which the piezoelectric element 410 is polarized. The first electrode 421 may be provided as a plurality of first electrodes 421, and the second electrode 422 may be provided as a plurality of second electrodes 422. In this case, the vibration part 400 may include a structure in which the first electrodes 421, the piezoelectric elements 410, the second electrodes 422, and the piezoelectric elements 410 are disposed alternately and repeatedly in the direction D1 in which the piezoelectric element 410 is polarized. For example, FIG. 9 illustrates a state in which five piezoelectric elements 410, three first electrodes 421, and three second electrodes 422 are alternately stacked in the vibration part 400. As illustrated in FIG. 9, the structure in which the piezoelectric elements 410 and the electrodes 421 and 422 of the vibration part 400 are disposed alternately and repeatedly may increase the voltage applied per unit thickness of the piezoelectric element 410, such that a displacement amount of the piezoelectric element 410 over time may increase even when a voltage is relatively low.

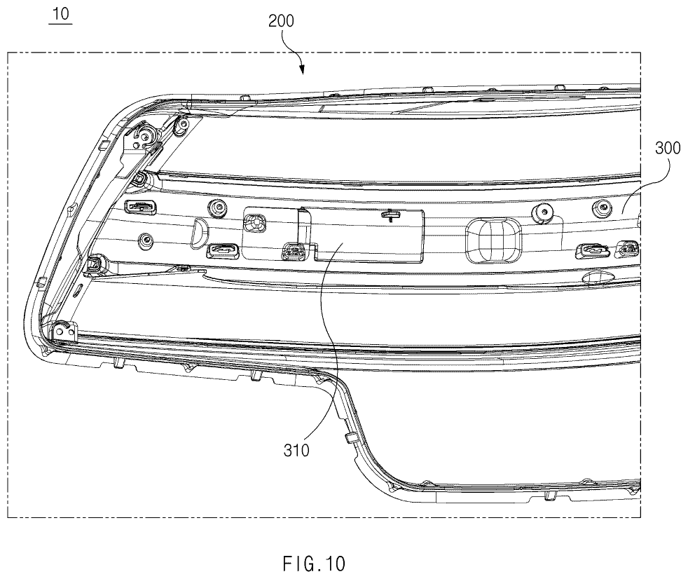

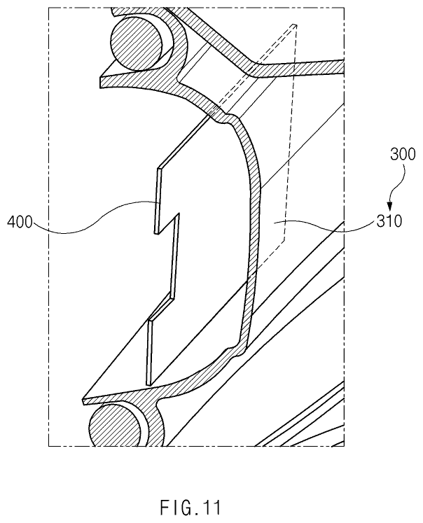

FIG. 10 is a view illustrating some components of a lamp for a vehicle according to a fourth embodiment of the present disclosure when viewed from a rear region of a lamp bezel part, and FIG. 11 is an enlarged view illustrating cross-sectional structures of a separation prevention region provided on the lamp bezel part in FIG. 10 and surrounding components thereof.

As described above, the lamp 10 according to the present disclosure may further include the lamp bezel part 300 having one side fixedly coupled to the lamp housing part 100, the lamp bezel part 300 being provided to at least partially face the outer lens part 200. The vibration part 400 may be fixed to the region of the outer lens part 200 that faces the lamp bezel part 300.

In this case, according to the fourth embodiment of the present disclosure, the lamp 10 may further include a configuration for preventing a situation in which the vibration part 400 falls and damages internal components of the lamp in case that the vibration part 400 is separated from the outer lens part 200. More specifically, the lamp bezel part 300 may have a separation prevention region 310 formed in a region facing the vibration part 400, the separation prevention region 310 being spaced apart from the vibration part 400. In this case, at least a part of the separation prevention region 310 may be positioned in a lower region of the vibration part 400 so that the vibration part 400 is supported by the separation prevention region 310 and does not collide with the other components in the lamp even though the vibration part 400 falls. In addition, the configuration in which the separation prevention region 310 is spaced apart from the vibration part 400 may serve to prevent a vibration force of the vibration part 400 from being transmitted to the separation prevention region 310. More particularly, as illustrated in FIGS. 10 and 11, the separation prevention region 310 may include a section having a concave shape and configured to surround the vibration part 400. Meanwhile, the description of the components, except for the separation prevention region, according to the fourth embodiment of the present disclosure may be replaced with the description of the lamp according to the present disclosure described above with reference to FIGS. 1 to 9.

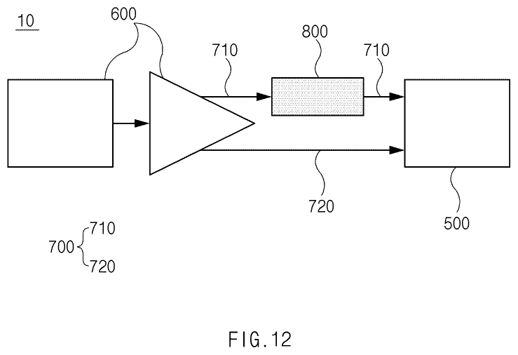

FIG. 12 is a view illustrating a first example including components for supplying electrical signals to the vibration part provided in the lamp for a vehicle according to the present disclosure.

With reference to FIG. 12, the lamp 10 according to the present disclosure may include a power supply part 500 configured to supply power to the first electrode and the second electrode, a signal supply part 600 configured to supply the power supply part 500 with an electrical signal related to a sound intended to be outputted by the vibration part, and a circuit part 700 configured to connect the power supply part 500 and the signal supply part 600 and provide a path through which the electrical signal is transmitted. That is, according to the present disclosure, when the signal supply part 600 sends the electrical signal, which is related to the sound intended to be outputted by the vibration part, to the power supply part 500 through the circuit part 700, the power supply part 500 may provide the vibration part with power corresponding to the electrical signal. Meanwhile, for example, the signal supply part 600 may include an audio amplifier (AMP) and a sound generator such as an audio DSP. The descriptions of the sound generator and the audio amplifier may be replaced with the descriptions publicly known in the related art. Meanwhile, the power supply part may be a part of the vibration part 400 as described above.

Meanwhile, with reference to FIG. 12, according to the first example, the lamp 10 according to the present disclosure may include a resistor member 800 provided on the above-mentioned circuit part 700.

The vibration part including the piezoelectric element and the electrode may have a tendency to decrease impedance as a frequency of power supplied to the electrode increases. Therefore, in case that high-frequency power is supplied to the vibration part, an overcurrent may flow through a circuit, which may cause a problem of damage to the circuit. Therefore, according to the present disclosure, the resistor member 800 may be provided on the circuit part 700, which may prevent an overcurrent from flowing through the circuit including the circuit part 700 even though high-frequency power is supplied to the vibration part.

Meanwhile, with continued reference to FIG. 12, the circuit part 700 may include a first circuit part 710 and a second circuit part 720 provided in parallel with each other. In this case, the above-mentioned resistor member 800 may be provided only on the first circuit part 710 or the second circuit part 720. This is because the impedance of the entire circuit including the circuit part 700 may be increased even though the resistor member 800 is provided only on one of the first circuit part 710 and the second circuit part 720. Meanwhile, the first circuit part 710 and the second circuit part 720 may be respectively electrically connected to the first electrode and the second electrode through the power supply part 500. Meanwhile, the resistor member 800 may be configured to have stationary electrical resistance. Alternatively, the resistor member 800 may be a variable resistor member.

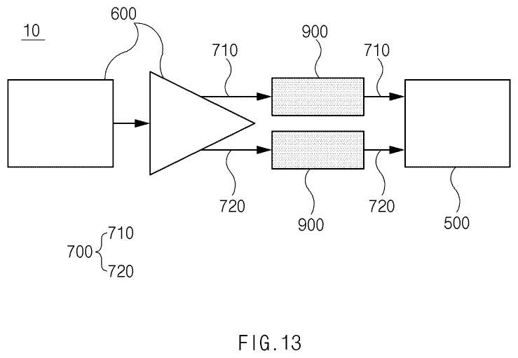

FIG. 13 is a view illustrating a second example including components for supplying electrical signals to the vibration part provided in the lamp for a vehicle according to the present disclosure.

With reference to FIG. 13, the lamp 10 according to the present disclosure may further include the power supply part 500 configured to supply power to the first electrode and the second electrode, the signal supply part 600 configured to supply the power supply part 500 with the electrical signal related to the sound intended to be outputted by the vibration part, the circuit part 700 configured to connect the power supply part 500 and the signal supply part 600 and define the path through which the electrical signal is transmitted, and filter members 900 provided on the circuit part 700 and configured to attenuate an electrical signal having a frequency that exceeds a predetermined value among the electrical signals. For example, the above-mentioned filter member 900 may be a low-pass filter (LPF). Like the resistor member according to the first example, the filter member 900 according to the second example may be configured to prevent the occurrence of an overcurrent in the circuit in case that high-frequency power is supplied to the vibration part. For example, the circuit part 700 may include the first circuit part 710 and the second circuit part 720 provided in parallel with each other, and the filter members 900 may be respectively provided on the first circuit part 710 and the second circuit part 720. Meanwhile, the descriptions of the components excluding the filter member 900 may be replaced with the description of the components described above with reference to FIG. 12.

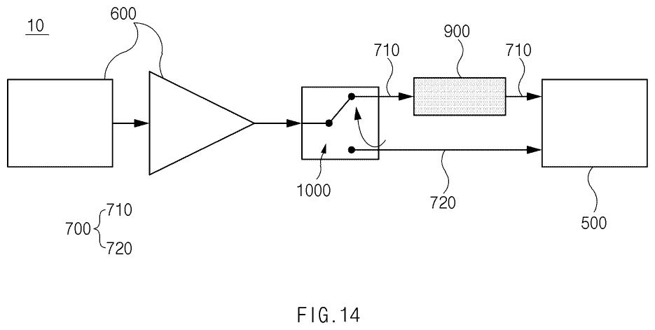

FIG. 14 is a view illustrating a third example including components for supplying electrical signals to the vibration part provided in the lamp for a vehicle according to the present disclosure.

With reference to FIG. 14, the lamp 10 according to the present disclosure may include the power supply part 500 configured to supply power to the first electrode 710 and the second electrode 720, the signal supply part 600 configured to supply the power supply part 500 with the electrical signal related to the sound intended to be outputted by the vibration part 400, the first circuit part 710 and the second circuit part 720 configured to connect the power supply part 500 and the signal supply part 600 and define the path through which the electrical signal is transmitted, the first circuit part 710 and the second circuit part 720 being provided in parallel with each other, and the filter member 900 provided on the first circuit part 710 and configured to attenuate an electrical signal having a frequency that exceeds the predetermined value among the electrical signals. In this case, as illustrated in FIG. 14, according to the third example, the lamp 10 may further include a switch member 1000 configured to connect the signal supply part 600 to the first circuit part 710 and the second circuit part 720 so that the signal supply part 600 is selectively connected to the first circuit part 710 or the second circuit part 720. That is, the switch member 1000 may be configured to supply an electrical signal of the signal supply part 600 to the power supply part 500 through any one of the first circuit part 710 and the second circuit part 720. For example, in case that a sound intended to be outputted is in a low sound range (e.g., a virtual engine sound), a high-frequency electrical signal needs to be attenuated. In this case, the switch member 1000 may be connected to the first circuit part 710 on which the filter member 900 is provided, such that a high-frequency electrical signal, among the electrical signals supplied to the power supply part 500 by the signal supply part 600, may be attenuated.

Meanwhile, as described above, the lamp 10 according to the present disclosure may include the power supply part 500 configured to supply power to the first electrode 421 and the second electrode 422, the signal supply part 600 configured to supply the power supply part 500 with the electrical signal related to the sound intended to be outputted by the vibration part 400, and the circuit part 700 configured to connect the power supply part 500 and the signal supply part 600 and define the path through which the electrical signal is transmitted. In this case, according to the present disclosure, the above-mentioned signal supply part 600 may operate to adjust intensity of an electrical signal within a predetermined frequency range among the electrical signals. More specifically, the signal supply part 600 may operate to amplify or attenuate the intensity of the electrical signal within the predetermined frequency range among the electrical signals, on the basis of the type of sound intended to be outputted. In order to perform the above-mentioned operation, the signal supply part 600 may further include a separate software filter or equalizer.

More specifically, the vibration part 400 may be configured to output first and second sounds having different vibration properties. In other words, the first sound and the second sound may mean different types of sounds. In this case, the signal supply part 600 may operate so that intensity according to the frequency of the electrical signal for outputting the first sound is different from intensity according to the frequency of the electrical signal for outputting the second sound. It may be understood that the signal supply part 600 operates to amplify or attenuate the electrical signal at least within a particular frequency range to output the first sound in comparison with when the second sound is outputted.

Meanwhile, as described above, the vibration part 400 may be fixed to the outer lens part 200, and the signal supply part 600 may operate to adjust the intensity of the electrical signal from the signal supply part 600 on the basis of a temperature of the outer lens part 200. This is to cope with physical rigidity in accordance with the temperature of the outer lens part 200. For example, the outer lens part 200 may be made of a polycarbonate (PC) material. The PC material becomes harder with a decrease in temperature and becomes more flexible with an increase in temperature. Therefore, in case that the temperature of the outer lens part 200 decreases, the vibration force of the outer lens part 200 may decrease even though the vibration force of the vibration part 400 remains the same. This phenomenon may be more significant in low-frequency vibration.

For example, according to the present disclosure, in case that the temperature of the outer lens part 200 is a predetermined value or less, the signal supply part 600 may operate to increase the intensity of the electrical signal transmitted from the signal supply part 600. Alternatively, according to the present disclosure, the signal supply part 600 may operate to increase the intensity of the electrical signal as the temperature of the outer lens part 200 decreases.

Meanwhile, according to the present disclosure, in case that the vibration part 400 is fixed to the outer lens part 200, the signal supply part 600 may operate to relatively increase the intensity of the high-frequency electrical signal as the temperature of the outer lens part 200 decreases. This may reflect the tendency of the outer lens part 200 to become harder as the temperature decreases. That is, according to the present disclosure, the signal supply part 600 may operate to relatively increase the intensity of the high-frequency electrical signal as the temperature of the outer lens part 200 decreases even though the same type of sound is outputted, such that it is possible to minimize a decrease in vibration force caused by the hardness of the outer lens part 200. For example, the signal supply part 600 may operate to increase the intensity of the electrical signal, which has a frequency exceeding a predetermined value among the electrical signals of the signal supply part 600, as the temperature of the outer lens part 200 decreases. In contrast, the signal supply part 600 may operate to decrease the intensity of the electrical signal, which has a frequency having a predetermined value or less among the electrical signals, as the temperature of the outer lens part 200 decreases.

Meanwhile, as described above, the resistor member 800 may be a variable resistor member. In this case, according to the present disclosure, the variable resistor member may operate to change resistance in accordance with a change in frequency of the signal supply part 600. More specifically, the variable resistor member may operate to increase resistance as the frequency of the signal supply part 600 increases, and the variable resistor member may operate to decrease resistance as the frequency of the signal supply part 600 decreases.

### Vehicle

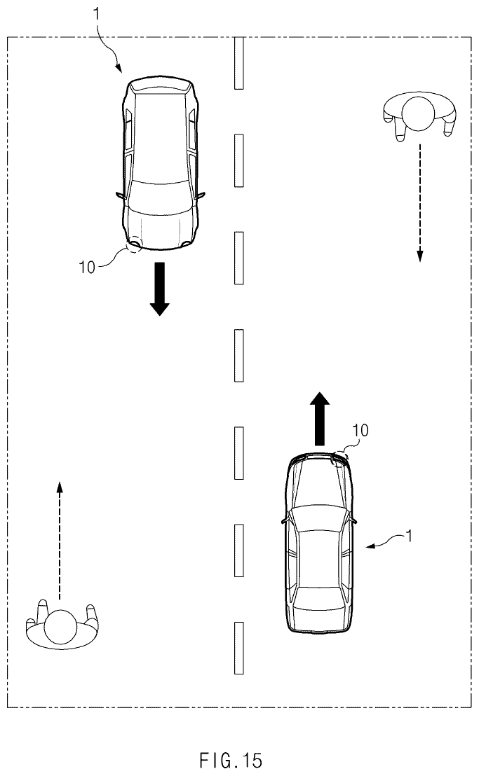

FIG. 15 is a view illustrating an example of a traveling state of a vehicle according to the present disclosure.

A vehicle 1 according to the present disclosure may include the lamp 10 for a vehicle. In this case, the lamp 10 for a vehicle, which is provided in the vehicle 1, may be the lamp 10 for a vehicle according to the present disclosure described above with reference to FIGS. 1 to 14.

In this case, according to the present disclosure, the lamp 10 according to the present disclosure described above with reference to FIGS. 1 to 14, i.e., the lamp 10 including the vibration part 400 may be provided only at a left or right side of the vehicle 1 according to the present disclosure. It may be understood that the sound generated by the vibration part 400 of the lamp 10 may be outputted only through the right or left side of the vehicle 1.

Whether the lamp 10 provided in the vehicle 1 according to the present disclosure is provided at the right or left side of the vehicle 1 may vary depending on whether the vehicle 1 according to the present disclosure is required to travel in a rightward or leftward direction on the roads of the country in which the vehicle 1 travels. More specifically, the lamp 10 of the vehicle 1 according to the present disclosure may be provided only at one of the left and right sides of the vehicle that is adjacent to a sidewalk when the vehicle 1 travels. For example, in a country where the vehicle 1 is required to travel on a right side of a roadway, the lamp 10 having the vibration part 400 may be provided only at the right side of the vehicle 1. In a country where the vehicle 1 is required to travel on a left side of a roadway, the lamp 10 having the vibration part 400 may be provided only at the left side of the vehicle 1. In case that the lamp 10 according to the present disclosure described above with reference to FIGS. 1 to 14 is provided at the right or left side of the vehicle 1 according to the present disclosure, the vehicle 1 may inform pedestrians of the presence of the vehicle by outputting a sound toward the pedestrians, thereby improving pedestrian safety.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A lamp for a vehicle, the lamp comprising:
a lamp housing part having an internal space configured to accommodate a light source;
an outer lens part coupled to one side of the lamp housing part and configured to cover the internal space; and
a vibration part fixed to the lamp housing part or the outer lens part,
wherein the vibration part comprises:
a polarized piezoelectric element configured to be polarized in a direction D1; and
a first electrode and a second electrode respectively facing two opposite sides based on the direction D1 in which the piezoelectric element is polarized, and
wherein the piezoelectric element outputs a sound by being vibrated by a change in voltage applied to the first electrode and the second electrode over time.

2. The lamp of claim 1, wherein the piezoelectric element is provided as a plurality of piezoelectric elements spaced apart from one another in the direction D1 in which the piezoelectric element is polarized,
wherein the first electrode is provided as a plurality of first electrodes,
wherein the second electrode is provided as a plurality of second electrodes, and
wherein the vibration part comprises a structure in which the first electrode, the piezoelectric element, the second electrode, and the piezoelectric element are disposed alternately in the direction D1 in which the piezoelectric element is polarized.

3. The lamp of claim 1, wherein the outer lens part comprises:
a first outer lens region having a first transmittance rate corresponding to a transmittance rate for visible rays; and
a second outer lens region having a second transmittance rate corresponding to a transmittance rate for visible rays lower than the first transmittance rate, and
wherein the vibration part is fixed to the second outer lens region.

4. The lamp of claim 1, wherein the vibration part is fixed to a lower region of an inner surface of the lamp housing part.

5. The lamp of claim 1, further comprising:
a lamp bezel part having one side fixedly coupled to the lamp housing part, the lamp bezel part being provided to at least partially face the outer lens part,
wherein the vibration part is fixed to a region of the outer lens part that faces the lamp bezel part,
wherein the lamp bezel part has a separation prevention region formed in a region facing the vibration part, and the lamp bezel part is spaced apart from the vibration part, and
wherein at least a part of the separation prevention region is positioned in a lower region of the vibration part.

6. The lamp of claim 5, wherein the separation prevention region comprises a section having a concave shape and is configured to surround the vibration part.

7. The lamp of claim 1, further comprising:
a power supply part configured to supply power to the first electrode and the second electrode;
a signal supply part configured to supply the power supply part with an electrical signal related to a sound intended to be outputted by the vibration part;
a circuit part configured to connect the power supply part and the signal supply part and provide a path through which the electrical signal is transmitted; and
a resistor member provided on the circuit part.

8. The lamp of claim 7, wherein the circuit part comprises a first circuit part and a second circuit part provided in parallel with each other, and
wherein the resistor member is provided only on the first circuit part or the second circuit part.

9. The lamp of claim 1, further comprising:
a power supply part configured to supply power to the first electrode and the second electrode;
a signal supply part configured to supply the power supply part with an electrical signal related to a sound intended to be outputted by the vibration part;
a circuit part configured to connect the power supply part and the signal supply part and provide a path through which the electrical signal is transmitted; and
a filter member provided on the circuit part and configured to attenuate an electrical signal having a frequency that exceeds a predetermined value among the electrical signals.

10. The lamp of claim 9, wherein the circuit part comprises a first circuit part and a second circuit part provided in parallel with each other, and
wherein the filter members are respectively provided on the first circuit part and the second circuit part.

11. The lamp of claim 1, further comprising:
a power supply part configured to supply power to the first electrode and the second electrode;
a signal supply part configured to supply the power supply part with an electrical signal related to a sound intended to be outputted by the vibration part; and
a circuit part configured to connect the power supply part and the signal supply part and provide a path through which the electrical signal is transmitted,
wherein the signal supply part is configured to adjust intensity of an electrical signal within a predetermined frequency range among the electrical signals.

12. The lamp of claim 1, further comprising:
a power supply part configured to supply power to the first electrode and the second electrode;
a signal supply part configured to supply the power supply part with an electrical signal related to a sound intended to be outputted by the vibration part; and
a circuit part configured to connect the power supply part and the signal supply part and provide a path through which the electrical signal is transmitted,
wherein the vibration part is fixed to the outer lens part, and
wherein the signal supply part is configured to adjust intensity of the electrical signal on the basis of a temperature of the outer lens part.

13. The lamp of claim 12, wherein the signal supply part is configured to increase the intensity of the electrical signal when the temperature of the outer lens part is a predetermined value or less.

14. The lamp of claim 12, wherein the signal supply part is configured to increase the intensity of the electrical signal as the temperature of the outer lens part decreases.

15. The lamp of claim 12, wherein the signal supply part is configured to at least one of:
increase the intensity of the electrical signal, which has a frequency exceeding a predetermined value among the electrical signals, as the temperature of the outer lens part decreases; or
decrease the intensity of the electrical signal, which has a frequency of a predetermined value or less among the electrical signals, as the temperature of the outer lens part decreases.

16. The lamp of claim 1, wherein the piezoelectric element has one of a circular shape, a square shape, and a rectangular shape.

17. The lamp of claim 7, wherein the resistor member comprises a variable resistor member, and
wherein the variable resistor member is configured to change resistance depending on a change in frequency of the electrical signal.

18. The lamp of claim 1, comprising:
a power supply part configured to supply power to the first electrode and the second electrode;
a signal supply part configured to supply the power supply part with an electrical signal related to a sound intended to be outputted by the vibration part;
a first circuit part and a second circuit part configured to connect the power supply part and the signal supply part and define a path through which the electrical signal is transmitted, the first circuit part and the second circuit part being provided in parallel with each other;
a filter member provided on the first circuit part and configured to attenuate an electrical signal having a frequency that exceeds a predetermined value among the electrical signals; and
a switch member configured to connect the signal supply part to the first circuit part and the second circuit part so that the signal supply part is selectively connected to the first circuit part or the second circuit part.

19. A vehicle wherein the lamp for a vehicle according to claim 1 is provided in at least one of a left side of the vehicle, a right side of the vehicle, or a combination thereof.

20. The vehicle of claim 19, wherein the lamp for a vehicle is provided only at one of the left side of the vehicle or the right side of the vehicle that is adjacent to a sidewalk when the vehicle travels.
